(19) United States
(12) Patent Application Publication
(10) Pub. No.: US 2007/0250229 A1
(43) Pub. Date: Oct. 25, 2007

(54) VEHICLE INFORMATION EARLY WARNING AND PARTS LIFE PREDICTION SYSTEM AND METHOD THEREFOR

(76) Inventor: Chih-Chen WU, Pingtung City (TW)

Correspondence Address: RABIN & Berdo, PC, 1101 14TH STREET, NW, SUITE 500, WASHINGTON, DC, 20005, US

(21) Appl. No.: 11/697,810

(22) Filed: Apr. 9, 2007

(30) Foreign Application Priority Data
Apr. 19, 2006 (TW) 095114013

(51) Int. Cl. G01M 17/00

(52) U.S. Cl. 701/29

(57) ABSTRACT

A vehicle information early warning and parts life prediction system and method therefor are provided, which includes a vehicle database connected to a mileage prediction unit, a maintenance prediction unit, a message management unit, and an auto care center management unit, in which information of vehicle is stored. The message management unit and a vehicle message receiver unit are connected by wireless communication or network connection. The mileage prediction unit analyzes vehicle traveling information. The maintenance prediction unit predicts the parts life and maintenance interval. The message management unit transmits a warning message to the vehicle message receiver unit. The auto care center management unit gets access to the vehicle database to manage and record a vehicle repair record and to control a parts inventory. The system is used for predicting the parts lifespan to immediately give a repair warning, thereby enhancing safety and security of traveling.

### CROSS-REFERENCE TO RELATED APPLICATIONS

This non-provisional application claims priority under 35 U.S.C. § 119(a) on Patent Application No(s). 095114013 filed in Taiwan, R.O.C. on Apr. 19, 2006, the entire contents of which are hereby incorporated by reference.

### BACKGROUND OF THE INVENTION

1. Field of Invention

The present invention relates to a vehicle information early warning and auto parts life prediction system. More particularly, the present invention relates to a safety prediction system capable of analyzing and predicting life of auto parts of a vehicle and sending out a message to a vehicle owner to know a current status of his/her vehicle before the life of auto parts reaches a safe lifespan.

2. Related Art

With the progress through the ages and advancement of science and technology, transportation vehicles become relatively complicated, and so does automobiles. However, the more complicated the mechanism is, the more easily the wear out of auto parts is. Especially, for machines moving at high speed like automobiles, due to factors such as different individual driving habits, residential climates, and frequencies of use of vehicle, and high temperature of engine during driving, the wear out of auto parts of vehicles differs and the extent of wear out are usually unperceivable.

For example, an engine drive belt of a vehicle is fabricated by a mixture of materials including rubber. The engine when operating at a high speed will drive wheels to move the vehicle by the engine drive belt. However, the quick operation of the engine will generate high temperature, and the engine drive belt is increasingly hardened and has cracks because of the high temperature, which cannot be easily perceived by vehicle owners. Therefore, it is possible that the engine drive belt breaks during driving, the vehicle breaks down on the way, or even worse the engine runs idle and finally is burnt down. The vehicle if running at high speed may be possibly out of control, and the vehicle owners or other vehicle are in danger.

In the prior art, the vehicle is usually sent by the owner to the auto care center or the auto repair shop for the repair, inspection, or car maintenance when the vehicle has problems. However, as driving habits and frequencies of use for different vehicle owners are different, it is impossible to effectively guarantee the driving safety of the vehicle solely depending on the periodical maintenance or the vehicle owners finding car fault on their own. In addition, currently no system or method has been proposed for managing the maintenance, inspection, and repair, so it is impossible to effectively predict the possibility of the fault of the vehicle and the fault parts. Therefore, a large amount of money will be spent for towage instead of paying a little of money to replace auto parts, and thus wasting a large amount of money, and it is more possible that the vehicle owner may gets a car accident and even lose life.

### SUMMARY OF THE INVENTION

Accordingly, the present invention provides a vehicle information early warning and parts life prediction system. Mainly, the system uses a vehicle repair/maintenance record and the auto parts information to analyze a vehicle driving habit of a vehicle owner, calculate and predict a term of safe service life of auto parts, transmits a warning message to remind the vehicle owner to have the vehicle repaired/maintained task within a time limit before the estimated time on which the parts are worn, and simultaneously provide a current status, repair/maintenance suggestion, and parts supply information of the vehicle to the vehicle owner.

The vehicle information early warning and parts life prediction system includes a vehicle database for storing various information of at least one vehicle. A mileage prediction unit is connected to the vehicle database to access a repair/maintenance record of the vehicle and analyze and predict an average mileage of the vehicle. A maintenance prediction unit is connected to the vehicle database to access the repair/maintenance record of the vehicle and the parts information of the vehicle to predict the time limit of vehicle maintaining and the parts lifespan. A message management unit is connected to the vehicle database to acquire the predicted repair/maintenance date and the safe lifespan of parts of the vehicle, and is connected to a vehicle message receiver unit by means of wireless communication or network connection, and transmits a warning message before the lifespan expires. The vehicle message receiver unit is used to receive the warning message. A network service unit is connected with the vehicle database by means of network connection to acquire the repair record of the vehicle and on-line order the parts. An auto care center management module is connected to the vehicle database by means of network connection. The auto care center management module at least includes a repair management unit and an inventory management unit. The repair management unit is used to access the repair/maintenance record of the vehicle and acquire the repair suggestion and repair decision of a repairman. The inventory management unit is used to manage the in and out flow of the inventory of the parts of the auto care center.

The present invention further includes a vehicle repair security prediction method, which includes the following steps: providing a vehicle database; acquiring a repair/maintenance record by the use of a mileage prediction unit; confirming whether the repair/maintenance record is altered, in which if yes, the mileage prediction unit predicts a latest average daily mileage of the vehicle, if no, the mileage prediction unit does not operate; predicting and storing the estimated repair/maintenance date of the vehicle by the use of a maintenance prediction unit; making a comparison to determine whether the date of the current day approaches or exceeds the repair/maintenance date by the use of a message management unit, in which if yes, a warning message is sent, if no, the signal management unit does not operate, and a step of using the mileage prediction unit to acquire the repair/maintenance record is repeated.

The present invention relates to a vehicle information early warning and parts life prediction system and a method therefor, and has the following advantages superior to the prior art and also has the following significant functional improvements.

1. According to the system and method of the present invention, the repair/maintenance record of the vehicle can be used to predict traveling status of different vehicles to calculate the safe lifespan of parts of the vehicle and transmits a warning message to suggest the vehicle owner to have the vehicle inspected and maintained within a time limit.

2. When the warning message is transmitted, the current status, relative information of the parts, and maintenance suggestion of the vehicle are provided to assist the vehicle owner to decide which maintenance method will be selected to maintain the optimal state of the vehicle.

3. If the vehicle owner has the vehicle repaired/maintained within the suggested time limit of the warning message, accidents such as the parts failure of the vehicle during driving can be avoided, thus greatly reducing the traveling danger, and to avoid the wear out of life and properties.

Further scope of applicability of the present invention will become apparent from the detailed description given hereinafter. However, it should be understood that the detailed description and specific examples, while indicating preferred embodiments of the invention, are given by way of illustration only, since various changes and modifications within the spirit and scope of the invention will become apparent to those skilled in the art from this detailed description.

### BRIEF DESCRIPTION OF THE DRAWINGS

The present invention will become more fully understood from the detailed description given herein below for illustration only, and thus is not limitative of the present invention, and wherein:

FIG. 1 is a schematic view of a system of the present invention; and

FIG. 2 is a flow chart of a vehicle safety prediction method of the present invention.

### DETAILED DESCRIPTION OF THE INVENTION

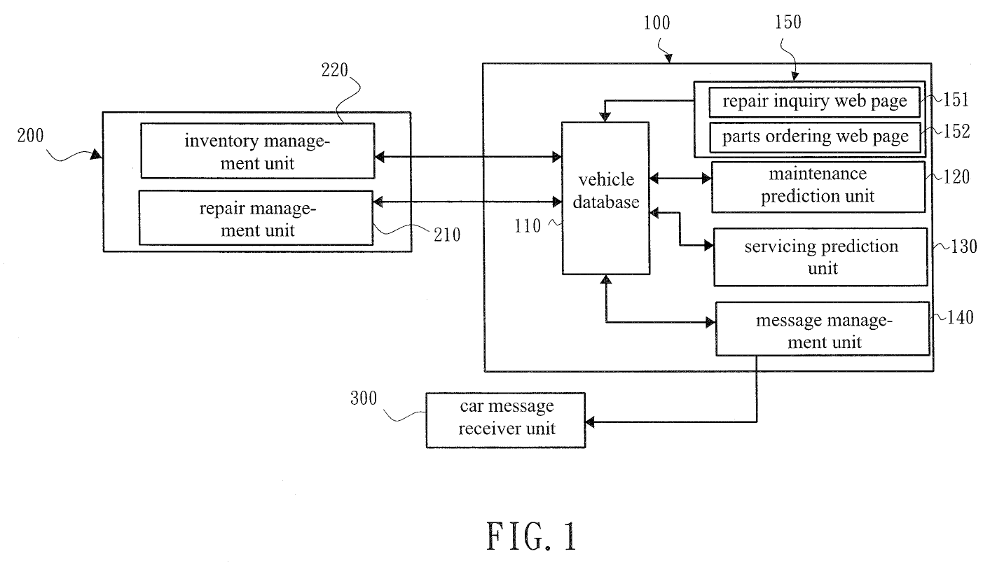

Referring to FIG. 1, it is a schematic view of a system of the present invention. The system includes a control module 100, an auto care center management module 200, and a vehicle message receiver unit 300.

The control module includes a network service unit 150, a vehicle database 110, a mileage prediction unit 120, a maintenance prediction unit 130, and a message management unit 140. The vehicle database 110 stores the information of at least one vehicle, in which the information includes a basic information, a repair/maintenance record, a part information, and a part inventory information of a vehicle.

The mileage prediction unit 120 is connected to the vehicle database 110 for periodically scanning the repair/maintenance record of each vehicle in the vehicle database 110, so as to acquire the basic information and the repair/maintenance record of the vehicle and detects whether the repair/maintenance record is altered. If yes, the mileage prediction unit 120 performs the following actions according to the acquired different information.

If the first repair/maintenance of the vehicle has not been carried out after vehicle is sold, the mileage prediction unit 120 does not operate.

If the vehicle has only one repair/maintenance record, a formula, Mileage of Current Repair/(Date of Current Repair−Original Date of Issue), is used to acquire a first average mileage. Here, the average daily mileage is the first average mileage, indicating that the average daily traveling distance of the vehicle before the repair/maintenance date of this time. After the calculation, the mileage is stored in the vehicle database 110.

If the vehicle has a plurality of repair/maintenance records, a formula, (Mileage of Current Repair−Mileage of Last Repair)/(Date of Current Repair−Date of Last Repair), is used to acquire a latest daily mileage, indicating that the average daily traveling distance of the vehicle between the last two times of repair. Then, a formula, (First Average Mileage+Latest Daily Mileage)/2, is used to acquire a second average mileage. Here, the average daily mileage is the second average mile number, indicating that the average daily traveling distance of the vehicle after being sold and is stored back into the vehicle database 110.

The mileage prediction unit 120 periodically scans the vehicle database 110, detects whether a new repair/maintenance record is added so as to perform calculation to acquire the average daily mileage and stores it back to the vehicle database 110.

The maintenance prediction unit 130 is connected to the vehicle database 110, operates after the mileage prediction unit 120 finishes operating, and has the following functions.

(1) Prediction of the date of periodical maintenance. The maintenance prediction unit 130 is used to acquire the repair/maintenance record of the vehicle, and the following operations are performed according to the acquired different information.

If the first repair/maintenance of the vehicle has not been carried out after the vehicle is sold, the maintenance prediction unit 130 does not operate.

If the vehicle has at least one repair/maintenance record, the maintenance prediction unit 130 firstly acquires the average daily mileage (e.g. 100 km), and the repair date (e.g. 2005 Feb. 15), the mileage of current repair (12046 km), and the estimated maintenance mileage (e.g. 17046 km) of the vehicle stored in the last repair/maintenance record. A formula (Maintenance mileage−Mileage of Current Repair)/Average Daily Mileage, e.g. (17046 km−12046 km)/100 km, is used to acquire the number of days (50 days). Then, the repair date (2005 Feb. 15) is used to deduce an estimated maintenance date (2005 Apr. 5), and the estimated maintenance date is stored in the vehicle database 110.

(2) Prediction of safe lifespan of parts. In the course of the repair/maintenance of the vehicle, the repairman inputs and stores the remaining mileage of the auto parts into the vehicle database 110. It is assumed that one of the parts is a tire, the remaining mileage is 2000 km, and the average daily mileage is 100 km, the repair date stored in the last repair/maintenance record of the vehicle is 2005 Feb. 15, a calculation formula, 2000 km/100 km, is used to acquire the number of days is 20. Therefore, the predicted parts replacement date is 2005 Mar. 5. The maintenance prediction unit 130 stores the parts replacement date back to the vehicle database 110.

(3) Prediction and analyses of parts life. An average durable mileage that auto parts can be safely used in a series of vehicle may be deduced. The maintenance prediction unit 130 is used to acquire the repair/maintenance record, and different operations are performed according to the acquired different information.

If the first repair/maintenance of the vehicle has not been carried out after the vehicle is sold, the maintenance prediction unit 130 does not operate.

If the vehicle has one repair/maintenance record, the current mileage is first acquired from the repair/maintenance record information. Here, the current mileage is equal to an average durable mileage, and is stored back into the vehicle database 110.

If the vehicle has a plurality of repair/maintenance records, the current durable mileage is calculated and acquired. Then, a formula, (Current Durable Mileage+Average Durable Mileage)/2, is used to acquire the latest average durable mileage, and the latest average durable mileage is stored back into the vehicle database 110.

After the average durable mileage is obtained, similarly, a formula, Average Durable Mileage/Average Daily Mileage, is used to acquire a predicted damage date of the parts, and the predicted damage date is stored back into the vehicle database 110.

The information of the parts are classified and stored into the vehicle database 110 according to brands, types, years, parts types, and latest average durable mileages.

(4) Prediction of new-type parts replacement date. For different types of vehicles, the wear out of parts cannot be regarded as the same. Those in the automobile industry when manufacturing parts will mark the predetermined safe time limit thereof for different types of vehicles. When the vehicle is repaired, if the new parts are replaced, a standard durable mileage of the new parts is stored in the vehicle database 110 with the repair/maintenance record. There are two calculation methods for predicting the safety lifespan of the new parts, namely “mileage” and “days of use”. If the “mileage” method is used, a formula, (Current mileage+Parts Metric Durable Mileage), is used to acquire a suggested replacement mileage. If the “days of use” method is used, a formula, Parts Metric Durable Mileage/Average Daily Mileage, is first used to acquire available days of parts. Then, a parts replacement date is added to acquire the information of a suggested parts replacement date, and the information is stored back into the vehicle database 110.

The message management unit 140 operates after the maintenance prediction unit 130 finishing operating, connects to the vehicle database 110, and is connected to the vehicle message receiver unit 300 by means of wireless communication or network connection. The repair/maintenance record of each vehicle in the vehicle database 110 is scanned step by step, and the date of the current day when the data is scanned is respectively compared with the periodical maintenance date, the practical average durable mileage of the auto parts, and the predicted damage date of the auto parts. If the compare result shows that date of data scanning approaches or exceeds the other date, a warning message is transmitted to the vehicle message receiver unit 300. The warning message is transmitted by means of an e-mail or a mobile phone short message.

The network service unit 150 is connected and gets access to the vehicle database 110. The network service unit 150 has a repair inquiry web page 151 for on-line querying of the repair/maintenance record of the vehicle, and a parts ordering web page 152 for the vehicle owners to acquire the supplier data of various parts, parts specification details, and prices freely. Additionally, it is possible to on-line order the auto parts and query the ordering record information.

The auto care center management module 200 is placed in the repair factories or service shops of various brands of vehicles. The auto care center management module 200 at least includes an inventory management unit 220 and a repair management unit 210. The inventory management unit 220 is connected to the vehicle database 110 by means of network connection. The information of the quantity of parts inventory of the repair factory is transmitted to and stored in the parts storage vehicle database 110 via the network. The repair management unit 210 is connected to the vehicle database 110 by means of network connection, the repair/maintenance record such as the scheduling of repair, parts replaced, suggestion and repair decision of the repairman is stored in the vehicle database 110 through the repair management unit 210. Moreover, the repair management unit 210 acquires the previous repair/maintenance record of the vehicle from the vehicle database 110, for the convenience of acquiring previous repair/maintenance records of the vehicle in different repairing factories or service shops, and the repair and parts replacement can be done under the suggestion of the system or the instruction of the vehicle owner. The publication of the repair record is more helpful for appraising the value of the vehicle in a used car market.

The vehicle message receiver unit 300 receives the warning message, and is connected to the message management unit by means of wireless communication or network connection. The content of the warning message includes the repair service suggestion information, parts replacement suggestion information, and network ordering information of various parts. The vehicle message receiver unit 300 may be a car computer, a personal computer, a 3G mobile phone, or a personal digital assistant (PDA) for receiving the e-mail or the short message.

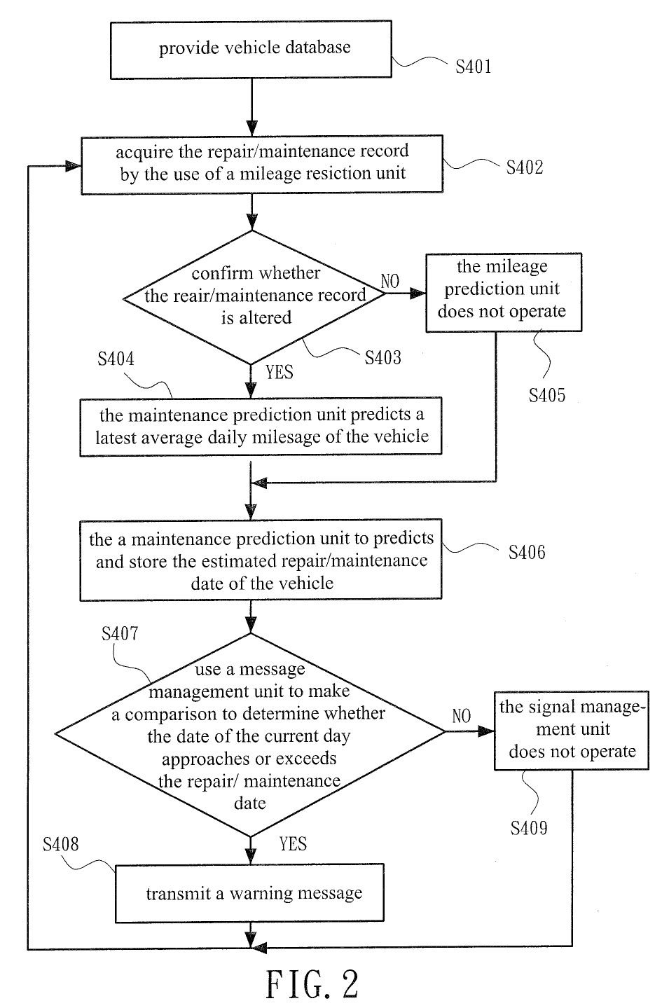

Referring to FIG. 2, it is a flow chart of the processes of the vehicle information early warning of the present invention, which includes the following steps:

A vehicle database is provided (step S401). The vehicle database stores a repair/maintenance record and a part information of at least one vehicle.

The repair/maintenance record is acquired by a mileage prediction unit (step S402). The mileage prediction unit is connected and gets access to the vehicle database.

It is confirmed whether the repair/maintenance record is altered (step S403). If no, the mileage prediction unit does not operate (step S405). If yes, the mileage prediction unit predicts a latest average daily mileage of the vehicle (step S404).

A maintenance prediction unit is used to predict and to store the estimated repair/maintenance date of the vehicle (step S406). The maintenance prediction unit is connected to the vehicle database to acquire the average daily mileage, repair/maintenance record, and parts data, predicts and calculates the estimated maintenance/repair date of the vehicle and the safe lifespan of the parts, and parts replacement date. Then, the date information is stored back into the vehicle database.

A message management unit is used to make a comparison whether the date of the current day approaches or exceeds the repair/maintenance date (step S407). The message management unit is connected to and scans the vehicle database, so as to acquire the periodical maintenance date, actual average durable mileage of the parts, and predicted damage date of the parts and compare them with the date of the current day. If the compare result is no, the signal management unit does not operate (step S409). On the contrary, a warning message is transmitted (step S408). For example, after the message management unit acquires the repair/maintenance record, when the difference between the estimated repair/maintenance date of the vehicle and the date of the current day is smaller than a determined number of days preset by the message management unit (e.g. the preset value is set to be ten days), after the message management unit determines that the compare result is smaller than the preset number of days, a warning message is sent out. The warning message can be a mobile phone short message, a telephone voice message, or an e-mail. A mileage prediction unit is repeatedly used to acquire the repair/maintenance record (step S402).

The invention being thus described, it will be obvious that the same may be varied in many ways. Such variations are not to be regarded as a departure from the spirit and scope of the invention, and all such modifications as would be obvious to one skilled in the art are intended to be included within the scope of the following claims.

What is claimed is:

1. A vehicle information early warning and parts life prediction system, comprising:
a vehicle database, in which a repair/maintenance record, a part inventory information, and a part information of at least one vehicle are stored;
a mileage prediction unit, connected and getting access to the vehicle database to acquire the repair/maintenance record, calculating an average daily mileage of the vehicle based on the repair/maintenance record; and storing back the average daily mileage into the vehicle database;
a maintenance prediction unit, connected and getting access to the vehicle database to acquire the repair/maintenance record and the parts information, calculating an estimated maintenance date information and a parts replacement date information of the vehicle based on the repair/maintenance record and the parts information, and storing back the information to the repair/maintenance record of the vehicle database;
a message management unit, connected and getting access to the vehicle database to acquire the estimated maintenance date information and the parts replacement date information, comparing the date information with the date of the current day, and if a compare result is smaller than a determined number of days preset by the message management unit, sending a warning message;
a vehicle message receiver unit, connected with the message management unit by means of network connection or wireless communication, and receiving the warning message; and
an auto care center management module, connected to the vehicle database by means of network connection, and getting access to the repair/maintenance record and the parts inventory information of the vehicle.

2. The vehicle information early warning and parts life prediction system as claimed in claim 1, further comprising a network service unit connected with the vehicle database by means of network connection and having a repair inquiry unit for on-line querying of the repair/maintenance record of the vehicle.

3. The vehicle information early warning and parts life prediction system as claimed in claim 2, wherein the network service unit further comprises a parts ordering unit for on-line acquiring the parts inventory information of a vehicle repair shop or a service shop and on-line ordering at least one part of the vehicle for a vehicle owner.

4. The vehicle information early warning and parts life prediction system as claimed in claim 1, wherein the vehicle message receiver unit is a car computer, a mobile phone, a personal computer, or a personal digital assistant (PDA).

5. The vehicle information early warning and parts life prediction system as claimed in claim 1, wherein the warning message is an e-mail.

6. The vehicle information early warning and parts life prediction system as claimed in claim 1, wherein the warning message is a mobile phone short message.

7. A vehicle information early warning method, comprising:
providing a vehicle database in which a repair/maintenance record and a parts information of at least one vehicle;
acquiring the repair/maintenance record by use of a mileage prediction unit that is connected and gets access to the vehicle database;
confirming whether the repair/maintenance record is changed, wherein if no, the mileage prediction unit does not operate, and if yes, the mileage prediction unit predicts a latest average daily mileage of the vehicle;
predicting and storing an estimated repair/maintenance date of the vehicle by use of a maintenance prediction unit, wherein the maintenance prediction unit is connected and gets access to the vehicle database, predicts and calculates a repair/maintenance date information of the vehicle, and stores the information into the vehicle database; and
making a comparison to determine whether date of current day approaches or exceeds the repair/maintenance date by use of a message management unit, wherein the message management unit is connected to and scans the vehicle database; after information about the estimated repair/maintenance date or a date of replacement of at least one part is obtained, compares the date information with the date of the current day; if a result approaches or exceeds, transmits a warning message; if not, the signal management unit does not operate, after the above step is finished, a mileage prediction unit is reused to acquire the step of repair/maintenance.

8. The vehicle information early warning method as claimed in claim 7, wherein the warning message is an e-mail.

9. The vehicle information early warning method as claimed in claim 7, wherein the warning message is a mobile phone short message.
